(19) United States
(12) Patent Application Publication
(10) Pub. No.: US 2024/0181918 A1
(43) Pub. Date: Jun. 6, 2024

(54) SERVER

(71) Applicants: TOYOTA JIDOSHA KABUSHIKI KAISHA, Toyota-shi (JP); DENSO CORPORATION, Kariya-city (JP)

(72) Inventors: Tateki HANASHIMA, Nagoya-shi (JP); Chiaki KANDA, Kariya-city (JP); Takaaki SANO, Izumi-shi (JP)

(73) Assignees: TOYOTA JIDOSHA KABUSHIKI KAISHA, Toyota-shi (JP); DENSO CORPORATION, Kariya-city (JP)

(21) Appl. No.: 18/385,452

(22) Filed: Oct. 31, 2023

(30) Foreign Application Priority Data
Dec. 6, 2022 (JP) 2022-194677

(51) Int. Cl. B60L 53/68; B60L 53/67; H02J 7/00

(52) U.S. Cl. CPC B60L 53/68; B60L 53/67; H02J 7/0013

(57) ABSTRACT

A CEMS server creates a first plan and a second plan such that a timing of a first change process of a first vehicle and a timing of a second change process of a second vehicle are staggered.

### CROSS-REFERENCE TO RELATED APPLICATION

This application claims priority to Japanese Patent Application No. 2022-194677 filed on Dec. 6, 2022, incorporated herein by reference in its entirety.

### BACKGROUND

### 1. Technical Field

The present disclosure relates to a server.

### 2. Description of Related Art

For example, Japanese Unexamined Patent Application Publication No. 2019-134522 discloses a management device that creates charge-discharge plans for charge-discharge processes of a plurality of electric storage devices. Each of the charge-discharge processes is at least one of charge and discharge.

### SUMMARY

In some cases, a configuration in which a change process of changing a charge-discharge current value in the charge-discharge process is executed is employed for more appropriately performing the charge-discharge processes of a plurality of electric charge devices. In the case where this configuration is applied to the above management device, the timings of the change processes of a first electric storage device and second electric storage device included in the plurality of electric storage devices sometimes coincide, and appropriate charge-discharge processes are not sometimes executed.

The present disclosure has been made for solving the above problem, and an object of the present disclosure is to create the charge-discharge plans for the first electric storage device and the second electric storage device such that the timing of a first change process of the first electric storage device and the timing of a second change process of the second electric storage device are staggered.

(1) A server includes a processor and a memory. The processor creates charge-discharge plans for charge-discharge processes of a plurality of electric storage devices, each of the charge-discharge processes being at least one of charge and discharge. The memory stores a program capable of being executed by the processor. The plurality of electric storage devices includes a first electric storage device and a second electric storage device. The first electric storage device performs a first change process of changing a charge-discharge current value in the charge-discharge process. The second electric storage device performs a second change process of changing a charge-discharge current value in the charge-discharge process. The processor creates a first plan and a second plan such that a timing of the first change process and a timing of the second change process are staggered, the first plan being the charge-discharge plan for the first electric storage device, the second plan being the charge-discharge plan for the second electric storage device.

In this configuration, the first electric storage device can perform the first change process of changing the charge-discharge current value in the charge-discharge process, and the second electric storage device can perform the second change process of changing the charge-discharge current value in the charge-discharge process. Moreover, the server can create the charge-discharge plans for the first electric storage device and the second electric storage device such that the timing of the first change process and the timing of the second change process are staggered. Accordingly, the server can appropriately execute the charge-discharge processes.

(2) The processor may create the first plan and the second plan such that a start timing of the charge-discharge process in the first plan and a start timing of the charge-discharge process in the second plan are staggered within an allowable period.

In this configuration, it is possible to create the first plan and the second plan such that the start timing of the first change process and the start timing of the second change process are staggered without hindering the charge-discharge processes.

(3) In the first change process, a process of changing the charge-discharge current value in the first electric storage device may be executed when a predetermined period elapses from start of the charge-discharge process of the first electric storage device. In the second change process, a process of changing the charge-discharge current value in the second electric storage device may be executed when the predetermined period elapses from start of the charge-discharge process of the second electric storage device.

In this configuration, even when the start timing of the first change process and the start timing of the second change process are the same, it is possible to stagger the timing of the first change process and the timing of the second change process.

(4) Each of the plurality of electric storage devices may perform a change process of changing the charge-discharge current value in the charge-discharge process, when a specified period elapses from start of the charge-discharge process of the electric storage device. The memory may store period information that indicates specified periods respectively corresponding to the plurality of electric storage devices. The processor may create the first plan and the second plan based on the period information.

In this configuration, it is possible to create the first plan and the second plan based on the period information, even when the plurality of electric storage devices includes a plurality of electric storage devices having different specified periods and a plurality of electric storage devices having an identical specified period.

(5) The first electric storage device and the second electric storage device may be respectively equipped in different vehicles. The plurality of electric storage devices may include a third electric storage device that is not equipped in a vehicle and that does not perform a change process in the charge-discharge process. The processor may create a third plan that is the charge-discharge plan for the third electric storage device. The processor may create the first plan and the second plan such that the timing of the first change process and the timing of the second change process are staggered, regardless of a start timing of the charge-discharge process in the third plan.

In this configuration, the first plan and the second plan are created such that the timing of the first change process and the timing of the second change process are staggered, even when the plurality of electric storage devices includes the third electric storage device that is not equipped in the vehicle and that does not perform the change process in the charge-discharge process.

With the present disclosure, it is possible to create the charge-discharge plans for the first electric storage device and the second electric storage device such that the timing of the first change process of the first electric storage device and the timing of the second change process of the second electric storage device are staggered.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of an electric power management system;

FIG. 2A is a diagram showing a charge plan and the like;

FIG. 2B is a diagram showing a charge plan and the like;

FIG. 3A is a diagram for describing a technique for creating a first provisional plan and the like;

FIG. 3B is a diagram for describing a technique for creating a second provisional plan and the like;

FIG. 3C is a diagram for describing a technique for creating a third provisional plan and the like;

FIG. 3D is a diagram for describing a technique for creating an integrative charge plan and the like;

FIG. 4 is a diagram showing an exemplary manner of charge;

FIG. 5 is a diagram showing an exemplary integrative charge plan for many vehicles; and

FIG. 6 is a diagram showing an exemplary period table.

### DETAILED DESCRIPTION OF EMBODIMENTS

Embodiments of the present disclosure will be described below in detail with reference to the drawings. In the figures, identical or corresponding parts are denoted by identical reference characters, and the descriptions are not repeated.

### First Embodiment

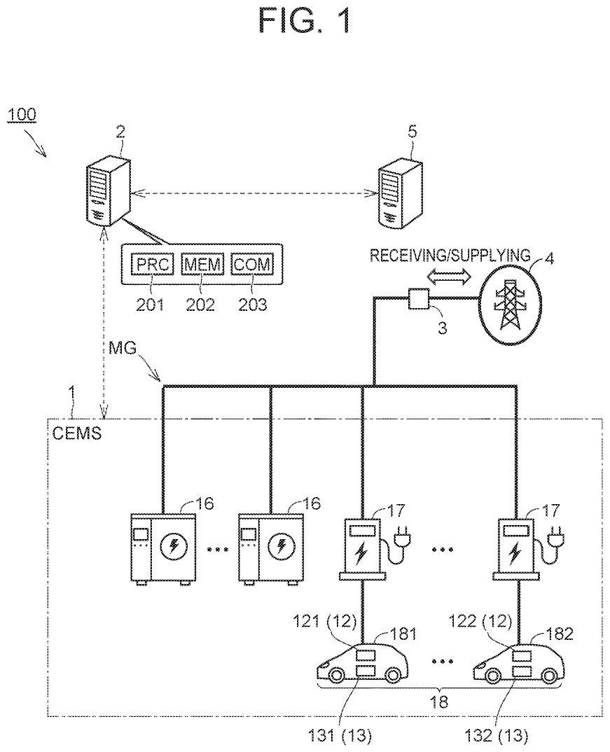

FIG. 1 is a diagram showing a schematic configuration of an electric power management system 100 according to a first embodiment. The electric power management system 100 includes a CEMS 1, a CEMS server 2, an electricity receiving and transforming facility 3, a utility grid 4, and an electricity transmitting and distributing operator server 5. The CEMS means a community energy management system or a city energy management system. For example, the electric power management system 100 is applied to a virtual power plant (VPP).

The CEMS 1 mainly includes at least one electric power storage system (ESS: Energy Storage System) 16, at least one electric power device 17, and at least one vehicle 18. In the CEMS 1, a microgrid MG is constructed by the constituent elements.

The electric power device 17 is a charging station for the charge of the vehicle 18 and the discharge from the vehicle 18. The vehicle 18 includes a battery 12 that can execute a charge-discharge process. The “charge-discharge process” is a process that is at least one of a charge process and a discharge process. The “charge-discharge current value” is at least one current value of a charge current value during the charge process and a discharge current value during the discharge process.

The battery 12 is a secondary battery such as a lithium-ion battery or a nickel hydrogen battery. Examples of the vehicle 18 include a plug-in hybrid electric vehicle (PHEV) and a battery electric vehicle (BEV). The vehicle 18 receives electric power from the microgrid MG (charge), while a charge cable extending from the electric power device 17 is connected to an inlet (not illustrated) of the vehicle 18. Further, the vehicle 18 may be configured to supply electric power to the microgrid MG (discharge), while the charge cable is connected to an outlet (not illustrated) of the vehicle 18.

The vehicle 18 includes a current sensor 13. For example, when the battery of the vehicle 18 is charged, the current sensor detects the charge current value. At least one vehicle 18 includes a first vehicle 181 and a second vehicle 182. The first vehicle 181 includes a first battery 121 as the above-described battery 12 and a first sensor 131 as the above-described current sensor 13. Further, the second vehicle 182 includes a second battery 122 as the above-described battery 12 and a second sensor 132 as the above-described current sensor 13. The first battery 121 corresponds to the “first electric storage device” in the present disclosure, and the second battery 122 corresponds to the “second electric storage device” in the present disclosure.

The electric power storage system 16 is a stationary electric storage device that stores electric power. The electric power storage system 16 corresponds to the “third electric storage device” in the present disclosure. The electric power storage system 16 is not equipped in the vehicle. For example, the electric power storage system 16 is constituted by a secondary battery such as a lithium-ion battery or a nickel hydrogen battery. Further, the electric power storage system 16 includes the above-described current sensor. As described above, the electric power management system 100 includes a plurality of electric storage devices.

The electricity receiving and transforming facility 3 is provided at an electricity receiving point (interconnection point) of the microgrid MG, and is configured to be capable of switching between parallel (connection) and parallel-off (disconnection) for the microgrid MG and the utility grid 4. The electricity receiving and transforming facility 3 includes a high-voltage side (primary side) opening and closing device, a transformer, a protection relay, a measurement instrument, and a control device, which are not illustrated. When the microgrid MG is interconnected with the utility grid 4, the electricity receiving and transforming facility 3 receives alternating-current power having, for example, a special voltage (a voltage exceeding 7000 V), from the utility grid 4, and steps down the received electric power to supply the electric power to the microgrid MG.

The utility grid 4 is an electric power grid that is constructed by electricity generating plants and electricity transmitting and distributing facilities. In the embodiment, an electric power company serves as an electricity generating operator and an electricity transmitting and distributing operator. The electric power company corresponds to a general electricity transmitting and distributing operator and an administrator of the utility grid 4, and maintains and manages the utility grid 4.

The electricity transmitting and distributing operator server 5 is a computer that is possessed by the electric power company and that manages the electric power demand and supply in the utility grid 4. The electricity transmitting and distributing operator server 5 is also configured to be capable of performing bidirectional communication with the CEMS server 2.

The CEMS server 2 manages the electric power storage system 16, the electric power device 17, and the vehicle 18. The CEMS server 2 corresponds to the “server” in the present disclosure. The CEMS server 2 includes a control device 201, a storage device 202, and a communication device 203. The control device 201 includes a processor, and is configured to execute a predetermined arithmetic process. The processor is also referred to as a control circuit. The storage device 202 includes a memory that stores programs to be executed by the control device 201. The communication device 203 includes a communication interface, and is configured to be capable of communicating with other devices. Examples of the other devices include the electricity transmitting and distributing operator server 5, the electric power storage system 16, the electric power device 17, and the vehicle 18.

The CEMS server 2 creates a charge-discharge plan based on a demand response (DR) request. The charge-discharge plan is a plan for the charge-discharge process of the electric power storage system 16 and the vehicle 18. An example of the charge process of the charge-discharge process of the battery of the vehicle 18 and the electric power storage system 16 will be mainly described. At intervals of a unit time (for example, one second), the CEMS server 2 sets command values indicating charge current values, and sends the command values to the electric power device 17 and the electric power storage system 16. The electric power device 17 charges the vehicle 18 at the charge current value indicated by the command value. Further, as described above, each of the vehicle 18 and the electric power storage system 16 includes the current sensor that detects the charge current value. Whenever the current sensor detects the charge current value, the current sensor sends the charge current value to the CEMS server 2. The CEMS server 2 executes a feedback control based on the sent charge current values, and sets the command values for the vehicle 18 and the electric power storage system 16. By such a feedback control, the CEMS server 2 can stably execute the charge process, even when a disturbance of the charge current occurs.

Further, during the execution of the charge process, the vehicle 18 executes a change process of changing the charge current value. An example of the change process will be described. Each vehicle 18 includes the current sensor 13 that detects the charge current value. The detection value of the current sensor 13 includes an offset error. Hence, by the change process, the vehicle 18 controls the charge current value to a predetermined value (for example, zero). Then, the vehicle 18 specifies the detection value of the current sensor 13 when the charge current value is zero, as the offset error, and corrects the detection value of the current sensor 13 such that the offset error is eliminated. This change process is disclosed in Japanese Unexamined Patent Application Publication No. 2011-209086, for example. Further, another example of the change process is disclosed in Japanese Unexamined Patent Application Publication No. 2020-124033, for example.

By the change process, the electric power management system 100 can execute stably the charge process. In the embodiment, each of the vehicles 18 included in the electric power management system 100 executes the change process at the timing when an identical predetermined period (for example, ten minutes) elapses from the timing of the start of the charge.

The change process that is executed by the first vehicle 181 is also referred to as a “first change process”, and the change process that is executed by the second vehicle 182 is also referred to as a “second change process”. That is, the first change process is a process that is executed when the predetermined period elapses from the start of the charge process of the first vehicle 181. Further, the second change process is a process that is executed when a period identical to the predetermined period elapses from the start of the change process of the second vehicle 182. Further, the electric power storage system 16 is configured so as not to execute the above-described change process. Accordingly, the process of the electric power storage system 16 can be simplified.

### Charge-Discharge Plan

Next, the charge-discharge plan will be described. The CEMS server 2 acquires the DR request from the electricity transmitting and distributing operator server 5 or the like. In the embodiment, the DR request is an increase DR request. For example, the increase DR request includes an electric power that needs to be consumed, and the like.

Further, the CEMS server 2 acquires trade information about electric power due to bidding from each user in an electric power market corresponding to the above VPP. For example, the trade information includes a desired charge power amount, a desired start time, and a desired end time for each user.

The CEMS server 2 specifies vehicles 18 and electric power storage systems 16 that are charge target devices, based on the trade information and predetermined information. For example, the predetermined information includes the traveling schedule of the vehicle 18, information indicating states of components of the vehicle 18, the state-of-charge (SOC) of the battery 12, the SOC of the electric power storage system 16, and the like. For example, the traveling schedule of the vehicle 18 includes the departure time of the vehicle 18, a planned traveling distance, and the like.

Then, the CEMS server 2 creates the charge plan for each of the vehicles 18 and electric power storage systems 16 that are charge targets. The charge plan is also referred to as a “provisional charge plan”. Further, the charge plan (provisional charge plan) for the first vehicle 181 is also referred to as a “first plan”, the charge plan (provisional charge plan) for the second vehicle 182 is also referred to as a “second plan”, and the charge plan for the electric power storage system 16 is referred to as a “third plan”.

In each provisional charge plan, a charge start time, a charge end time, a charge power amount, and the like are prescribed. Further, as described later, in the embodiment, the charge start time is sometimes altered to an earlier time. Hence, for the charge start time, an allowable period is prescribed. For example, the allowable period may be a previously set value, or may be calculated by a predetermined technique. In the embodiment, the charge start time is altered such that the difference value between a charge start time before the alteration and a charge start time after the alteration is equal to or less than the allowable period.

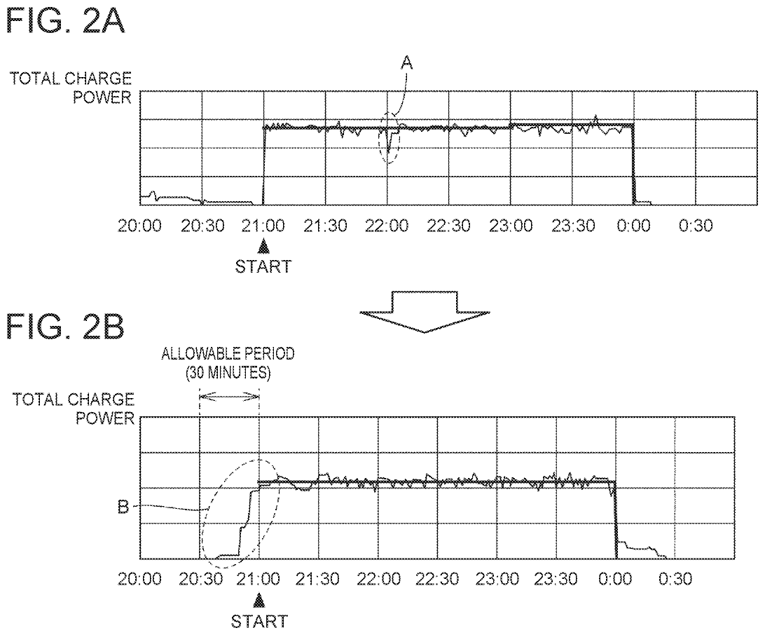

Each of FIG. 2A and FIG. 2B is a diagram showing an example of the transition of charge power in a comprehensive charge plan in which the respective provisional charge plans for the vehicles 18 and electric power storage systems 16 as charge targets are integrated. FIG. 2A is an example of the transition of charge power in a comprehensive charge plan in a comparative example, and FIG. 2B is an example of the transition of charge power in a comprehensive charge plan in the embodiment. In FIG. 2A and FIG. 2B, the ordinate axis indicates the total charge power of the vehicles 18 and electric power storage systems 16 as charge targets, and the abscissa axis indicates time. Further, in the example in FIG. 2B, the allowable period is set to 30 minutes.

FIG. 2A shows a case where the charge start time in each charge plan for the vehicles 18 and electric power storage systems 16 as charge targets is 21:00. As described above, all vehicles 18 execute the above-described change process (the process of adjusting the charge current value to zero) at the timing when the identical predetermined period elapses from the timing of the start of the charge. Accordingly, the timing when the charge current value becomes zero coincides in the plurality of vehicles 18. Since the timing coincides, a sharp drop in charge power value occurs as shown in a spot A in FIG. 2A. The sharp drop causes a disadvantage in that the CEMS server 2 generates command values for charge with a large amount of electric power (an unexpected electric power) for eliminating the drop by the above-described feedback control. Further, the sharp drop causes a possibility that the charge process is not stably performed.

Hence, in the embodiment, the CEMS server 2 creates the first plan (charge plan) for the first vehicle 181 and the second plan (charge plan) for the second vehicle 182, such that the timing of the first change process and the timing of the second change process are staggered. In other words, the CEMS server 2 creates the first and second plans in which the timing of the first change process and the timing of the second change process are staggered. The timing of the change process is the timing of the start of the change process, for example.

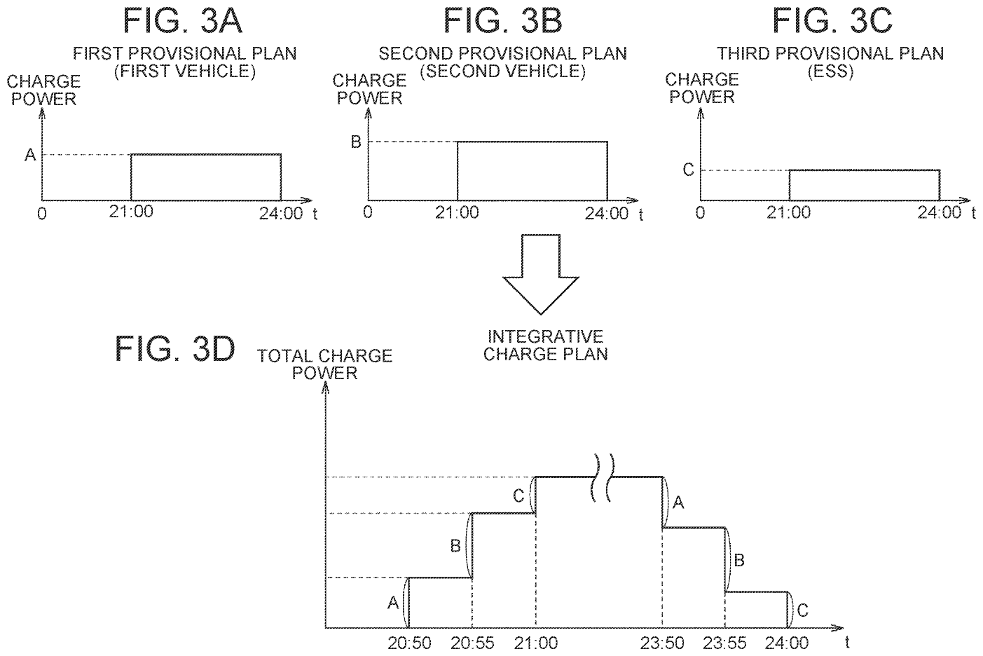

FIG. 3A, FIG. 3B, FIG. 3C and FIG. 3D are diagrams for describing a first provisional plan, a second provisional plan, a third provisional plan, and the like. In FIG. 3A, FIG. 3B, FIG. 3C, and FIG. 3D, a case where charge target devices are the first vehicle 181, the second vehicle 182, and one electric power storage system 16 is described. As described above, the first provisional plan is a provisional charge plan for the first vehicle 181, the second provisional plan is a provisional charge plan for the second vehicle 182, and the third provisional plan is a provisional charge plan for the electric power storage system 16.

In the first provisional plan, it is prescribed that the charge start time is 21:00, the charge end time is 24:00, and the charge power is A. In the second provisional plan, it is prescribed that the charge start time is 21:00, the charge end time is 24:00, and the charge power is B. In the third provisional plan, it is prescribed that the charge start time is 21:00, the charge end time is 24:00, and the charge power is C.

When the CEMS server 2 executes the charge processes in accordance with the first provisional plan, the second provisional plan and the third provisional plan, a sharp drop can occur as described by the spot A in FIG. 2A. Hence, the CEMS server 2 creates the first plan (the charge plan for the first vehicle 181) and the second plan (the charge plan for the second vehicle 182) such that the timing of the change process (the first change process) of the first vehicle 181 and the timing of the change process (the second change process) of the second vehicle 182 are staggered.

In the embodiment, the CEMS server 2 staggers the start timing of the charge process in the first provisional plan and the start timing of the charge process in the second provisional plan. The CEMS server 2 randomly decides a vehicle for which the start timing of the charge process is staggered. As a modification, the CEMS server 2 may decide the vehicle for which the start timing of the change process is staggered, such that a predetermined condition is satisfied (for example, such that a start time desired by the user is satisfied).

FIG. 3D is an exemplary comprehensive charge plan in which the first provisional plan, the second provisional plan, and the third provisional plan are integrated. In the example in FIG. 3D, the first plan is advanced by ten minutes, and the second plan is advanced by five minutes. That is, the charge start time of the first vehicle 181 is 20:50, and the charge start time of the second vehicle 182 is 20:55. Further, as described above, the electric power storage system 16 does not execute the change process. Accordingly, the charge of the electric power storage system 16 does not contribute to the above-described sharp drop. Consequently, the CEMS server 2 does not alter the start timing in the third provisional plan. That is, in the example in FIG. 3D, the start timing in the third provisional plan is 21:00 with no change.

Further, the CEMS server 2 staggers the timing of the first change process and the timing of the second change process, such that the period between the timing of the first change process and the timing of the second change process is a previously set period (referred to as a “shift period”, hereinafter). For example, the shift period is a value based on “Third-Order Adjusting Power 2”, and is set to “five minutes”. Further, the shift period is also referred to as an “evaluation segment”. Further, the CEMS server 2 may stagger the timing of the first change process and the timing of the second change process, such that the period between the timing of the first change process and the timing of the second change process is a multiple of the shift period.

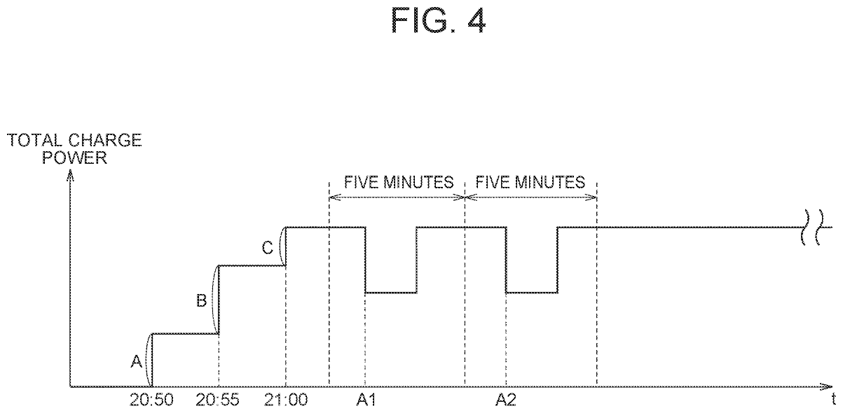

FIG. 4 is a diagram showing an example of the transition of the charge power when the first vehicle 181, the second vehicle 182, and the electric power storage system 16 are charged in accordance with the comprehensive charge plan (see FIG. 3D). Hereinafter, a control to create the charge plan such that the start timings of the change processes of the vehicle are staggered is also referred to as a “shift control”. As shown in FIG. 4, since the CEMS server 2 executes the shift control, a start timing A1 of the first change process and a start timing A2 of the second change process can be staggered by the shift period (five minutes in the example in FIG. 4). Accordingly, it is possible to avoid the sharp drop from occurring (see the spot A in FIG. 2A).

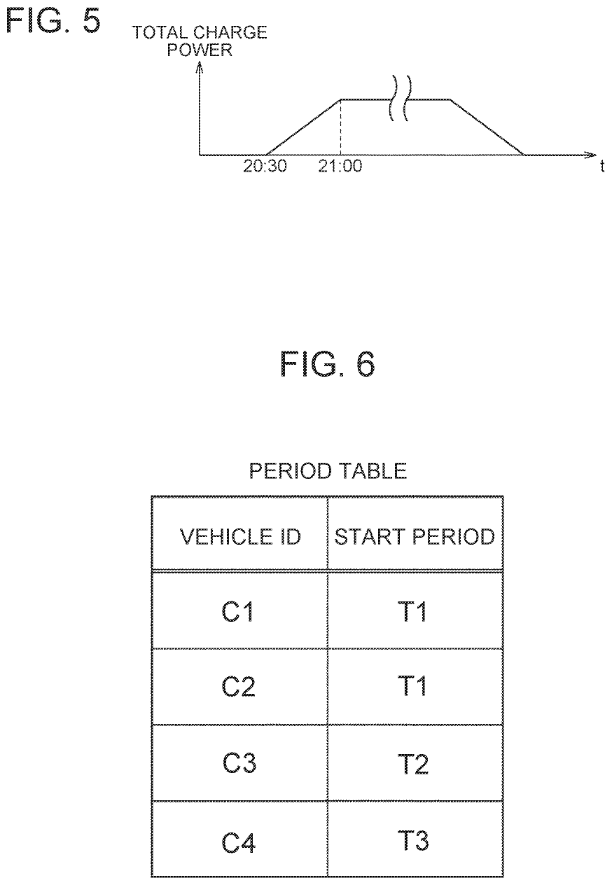

FIG. 5 is a diagram showing an example of the comprehensive charge plan when many vehicles 18 are charged. In FIG. 3D, since two vehicles are charged, the total charge power changes stepwise, during a specified period from a time (20:30) of the allowable period before the start timing (21:00) in the provisional charge plan to the start timing (21:00) in the provisional charge plan. On the other hand, in the case where many vehicles are charged, the total charge power changes linearly during the specified period. Further, in the case where many vehicles (for example, three or more vehicles) are charged, the CEMS server 2 staggers the respective timings of the change processes of the many vehicles, such that each of the respective timings of the change processes of the many vehicles is staggered by the shift period. In this configuration, it is possible to avoid the sharp drop from occurring (see the spot A in FIG. 2A).

In this way, each of the vehicles 18 (the first vehicle 181 and the second vehicle 182) performs the change process. Accordingly, the CEMS server 2 can stably execute the charge processes. Moreover, the CEMS server 2 creates the charge plans for a plurality of vehicles 18 (for example, the first vehicle 181 and the second vehicle 182), such that the timing of the first change process and the timing of the second change process are staggered (see FIG. 3D). In other words, the CEMS server 2 creates the charge plans for a plurality of vehicles 18 in which the timing of the first change process and the timing of the second change process are staggered. Accordingly, the CEMS server 2 can stagger the timing of the first change process of the first vehicle 181 and the timing of the second change process of the second vehicle 182. Consequently, the CEMS server 2 can avoid the sharp drop in charge power, can avoid the above disadvantage, and can appropriately execute the charge processes.

Further, the CEMS server 2 staggers the start timing of the charge process in the first plan and the start timing of the charge process in the second plan, such that the start timing of the charge process in the first plan and the start timing of the charge process in the second plan fall within the allowable period (30 minutes in the embodiment). In other words, the CEMS server 2 staggers the start timing of the charge process in the first plan and the start timing of the charge process in the second plan, within the allowable period. Thereby, the CEMS server 2 can create the first plan and the second plan such that the start timing of the first change process and the start timing of the second change process are staggered within the allowable period. Accordingly, the CEMS server 2 can stagger the timing of the first change process and the timing of the second change process, by staggering the start timing of the charge-discharge process in the first plan and the start timing of the charge-discharge process in the second plan without hindering the charge-discharge processes. Consequently, the CEMS server 2 can stagger the timing of the first change process and the timing of the second change process, by staggering the start timing of the charge-discharge process in the first plan and the start timing of the charge-discharge process in the second plan without hindering the charge-discharge processes.

Further, in the embodiment, the start timing after the start of the charge is the same between the first change process and the second change process. Even when a simple configuration in which the start timing is the same is employed, the CEMS server 2 can stagger the timing of the first change process and the timing of the second change process.

Further, the electric power storage system 16 does not execute the change process. Accordingly, it is possible to simplify the configuration of the electric power storage system 16. Furthermore, the CEMS server 2 creates the first plan and the second plan such that the timing of the first change process and the timing of the second change process are staggered, regardless of the start timing of the charge process in the third plan for the electric power storage system 16. Accordingly, even in the case where the electric power management system 100 includes the electric power storage system 16 that is not equipped in the vehicle 18 and that does not perform the change process in the charge-discharge process, the CEMS server 2 can create the first plan and the second plan such that the timing of the first change process and the timing of the second change process are staggered. In the embodiment, the example in which the CEMS server 2 does not alter the start timing in the third plan for the electric power storage system 16 has been described. However, as a modification, the CEMS server 2 may alter the start timing in the third plan for the electric power storage system 16.

### Second Embodiment

In the embodiment, a plurality of electric storage devices executes the change process. Hereinafter, it is assumed that the plurality of electric storage devices includes a fourth electric storage device. The fourth electric storage device may be the electric power storage system 16 or the vehicle 18. In the second embodiment, the fourth electric storage device is a vehicle.

In the second embodiment, a configuration in which the start timings of the first vehicle 181 and the second vehicle 182 that are charge target devices are the same and the start timings of the change processes of the first vehicle 181 and the fourth electric storage device are different will be described. In the case where this configuration is employed, when the CEMS server 2 alters the start timing of the change process of the first vehicle 181 and the start timing of the change process of the fourth electric storage device without referring to any information, the start timing of the change process of the first vehicle 181 and the start timing of the change process of the fourth electric storage device can coincide with each other.

Hence, in the second embodiment, the CEMS server 2 creates the charge plans (the first plan, the second plan, and the like) for the plurality of electric storage devices that are charge target devices, using a period table. Accordingly, even when a plurality of electrification devices (for example, the first vehicle 181 and the fourth electric storage device) in which the start timings of the change processes are staggered is included in the charge target devices, it is possible to avoid the start timings of the plurality of electrification devices from coinciding with each other.

The storage device 202 (memory) of the CEMS server 2 in the second embodiment stores the above-described period table. FIG. 6 shows an example of the period table. The period table is a table in which a period (also referred to as a “start period”, hereinafter) from the start of the charge to the start timing of the change process is prescribed for each vehicle identification (ID). Further, the vehicle ID is given to each of all vehicles included in the electric power management system 100. The period table corresponds to the “period information” in the present disclosure. Further, the start period corresponds to the “specified period” in the present disclosure.

For example, in the example in FIG. 6, each start period of a vehicle 18C1 for which the vehicle ID is C1 and a vehicle 18C2 for which the vehicle ID is C2 is T1. Further, it is prescribed that the start period of a vehicle 18C3 for which the vehicle ID is C3 is T2. It is prescribed that the start period of a vehicle 18C4 for which the vehicle ID is C4 is T3.

The CEMS server 2 acquires the respective vehicle IDs of the plurality of vehicles 18 included in the charge target devices, and acquires the start periods corresponding to the vehicle IDs by referring to the period table. Then, based on the acquired start periods, the CEMS server 2 creates the charge plans for the plurality of vehicles 18, such that the timings of the respective change processes of the plurality of vehicle 18 included in the charge target devices are staggered.

For example, in the example in FIG. 6, since the start periods of the vehicle 18C1 and the vehicle 18C2 are the same, the start timing of the charge process of the vehicle 18C1 is altered so as to be different from those of the vehicle 18C2, the vehicle 18C3, and the vehicle 18C4.

In this configuration, even when the plurality of electric storage devices includes a plurality of electric storage devices (the vehicle 18C1 and the vehicle 18C2) having the same start period and a plurality of electric storage devices (the vehicle 18C1, the vehicle 18C3, and the vehicle 18C4) having different specified periods, the CEMS server 2 can create the charge plans (for example, the first plan and the second plan) for the plurality of electric storage devices based on the period table.

### OTHER EMBODIMENTS

(1) In the above-described embodiments, the case where the increase DR is issued and the charge processes of the vehicle 18 and the electric power storage system 16 are executed has been mainly described. However, the above idea may be applied to a case where a decrease DR is issued and the discharge processes of the vehicle 18 and the electric power storage system 16 are executed. That is, even in the case where the discharge processes of the vehicle 18 and the electric power storage system 16 are executed, the vehicle 18 executes the change process during the discharge process for stably executing the discharge process. Then, the CEMS server 2 creates the first plan and the second plan such that the timing of the first change process during the discharge process of the first vehicle 181 and the timing of the second change process during the discharge process of the second vehicle 182 are staggered. In this configuration, during the discharge processes, the CEMS server 2 can avoid a sharp drop in discharge power, and can appropriately execute the discharges.

(2) In the above-described embodiments, the configuration in which the electric power storage system 16 does not execute the change process has been described. However, the electric power storage system 16 may execute the change process. In this case, the electric power storage system 16 is included in the target devices for which the CEMS server 2 staggers the start timing in the charge-discharge plan.

(3) In the above-described embodiments, the example in which the condition of the execution of the shift control by the CEMS server 2 is the condition that two or more vehicles are charged has been described. However, the condition of the execution of the shift control by the CEMS server 2 may be another condition. For example, the other condition may be a condition that a total electric power amount that is decreased due to the change processes of all vehicles as charge target devices is equal to or more than a predetermined value. Under this condition, in the case where the total electric power amount that is decreased is less than the predetermined value, the shift control is not executed, and therefore it is possible to increase the proportion of a situation in which the charge plan is created in accordance with the provisional charge plan.

It should be understood that the embodiments disclosed herein are examples and are not limitative in all respects. It is intended that the scope of the present disclosure is shown not by the above descriptions of the embodiments but by the claims and includes all alterations in a meaning and range equivalent to the claims.

What is claimed is:

1. A server comprising:
a processor that creates charge-discharge plans for charge-discharge processes of a plurality of electric storage devices, each of the charge-discharge processes being at least one of charge and discharge; and
a memory that stores a program capable of being executed by the processor, wherein:
the plurality of electric storage devices includes a first electric storage device and a second electric storage device;
the first electric storage device performs a first change process of changing a charge-discharge current value in the charge-discharge process;
the second electric storage device performs a second change process of changing a charge-discharge current value in the charge-discharge process; and
the processor creates a first plan and a second plan such that a timing of the first change process and a timing of the second change process are staggered, the first plan being the charge-discharge plan for the first electric storage device, the second plan being the charge-discharge plan for the second electric storage device.

2. The server according to claim 1, wherein the processor creates the first plan and the second plan such that a start timing of the charge-discharge process in the first plan and a start timing of the charge-discharge process in the second plan are staggered within an allowable period.

3. The server according to claim 1, wherein:
in the first change process, a process of changing the charge-discharge current value in the first electric storage device is executed when a predetermined period elapses from start of the charge-discharge process of the first electric storage device; and
in the second change process, a process of changing the charge-discharge current value in the second electric storage device is executed when the predetermined period elapses from start of the charge-discharge process of the second electric storage device.

4. The server according to claim 1, wherein:
each of the plurality of electric storage devices performs a change process of changing the charge-discharge current value in the charge-discharge process, when a specified period elapses from start of the charge-discharge process of the electric storage device;
the memory stores period information that indicates specified periods respectively corresponding to the plurality of electric storage devices; and
the processor creates the first plan and the second plan based on the period information.

5. The server according to claim 1, wherein:
the first electric storage device and the second electric storage device are respectively equipped in different vehicles;
the plurality of electric storage devices includes a third electric storage device that is not equipped in a vehicle and that does not perform a change process in the charge-discharge process; and
the processor
creates a third plan that is the charge-discharge plan for the third electric storage device, and
creates the first plan and the second plan such that the timing of the first change process and the timing of the second change process are staggered, regardless of a start timing of the charge-discharge process in the third plan.
